(19) United States
(12) Patent Application Publication
(10) Pub. No.: US 2016/0335592 A1
(43) Pub. Date: Nov. 17, 2016

(54) MODULAR DATA LOGGING SYSTEM WITH COMBINED DATA LOGS

(71) Applicant: Carrier Corporation, Farmington, CT (US)

(72) Inventor: Stephen Varga, Bedford, NH (US)

(21) Appl. No.: 15/147,076

(22) Filed: May 5, 2016

Related U.S. Application Data
(60) Provisional application No. 62/160,956, filed on May 13, 2015.

(51) Int. Cl. G06Q 10/08; G06F 17/30

(52) U.S. Cl. CPC G06Q 10/0832; G06F 17/30368

(57) ABSTRACT

A method and system for data logging includes a parent data logger to log a parameter of interest in a parent log for a primary period, a plurality of child data loggers to log the parameter of interest in a respective plurality of child logs for a respective plurality of secondary periods, a controller to generate a plurality of combined logs, wherein each combined log is generated by combining the parent log with a respective child log of the plurality of child logs.

### CROSS-REFERENCE TO RELATED APPLICATIONS

This application claims the benefit of U.S. provisional patent application Ser. No. 62/160,956, filed May 13, 2015, the entire contents of which are incorporated herein by reference.

### TECHNICAL FIELD

The subject matter disclosed herein relates to modular data loggers, and to a system and a method for logging data with combined data logs.

### DESCRIPTION OF RELATED ART

Typically, cold chain distribution systems are used to transport and distribute temperature sensitive and perishable goods. For example, food, industrial goods, and pharmaceuticals may be susceptible to temperature, humidity, and other environmental factors. Advantageously, cold chain systems allow perishable and environmentally sensitive goods to be effectively transported and distributed without damage or other undesirable effects.

Environmental parameter loggers are often used in in cold chain distribution systems to monitor the conditions and integrity of the cold chain and consequently the goods transported. Cold chain systems often have multiple distribution points where cargo are divided or reallocated between segments. Current environmental parameter logging systems may log data of certain segments of distribution, but may not provide complete information or logs associated with cargo divided or reallocated between segments. A system and method that can provide combined data logs is desired.

### BRIEF SUMMARY

According to an embodiment, a data logging system includes a parent data logger to log a parameter of interest in a parent log for a primary period, a plurality of child data loggers to log the parameter of interest in a respective plurality of child logs for a respective plurality of secondary periods, a controller to generate a plurality of combined logs, wherein each combined log is generated by combining the parent log with a respective child log of the plurality of child logs.

In addition to one or more of the features described above, or as an alternative, further embodiments could include that the parent data logger and each of the plurality of child data loggers are releasably coupled.

In addition to one or more of the features described above, or as an alternative, further embodiments could include that at least one respective secondary period of the plurality of secondary periods is initiated in response to releasing at least one child data logger of the plurality of child data loggers from the parent data logger.

In addition to one or more of the features described above, or as an alternative, further embodiments could include that the parent data logger and the plurality of child data loggers are electrically coupled.

In addition to one or more of the features described above, or as an alternative, further embodiments could include that the parent data logger and each of the plurality of the child data loggers each has a unique identifier.

In addition to one or more of the features described above, or as an alternative, further embodiments could include that the parameter of interest includes at least one of a temperature value, a humidity value, and a gas level.

In addition to one or more of the features described above, or as an alternative, further embodiments could include that the parent data logger and the plurality of child data loggers log at least one time stamp.

In addition to one or more of the features described above, or as an alternative, further embodiments could include that the parent data logger and the plurality of child data loggers log at least one location value.

In addition to one or more of the features described above, or as an alternative, further embodiments could include that the parent data logger and the plurality of child data loggers each include at least one of a wireless data interface and a wired data interface.

According to an embodiment, a method to log data includes logging a parameter of interest in a parent log for a primary period via a parent data logger, logging the parameter of interest in a plurality of child logs for a respective plurality of secondary periods via a respective plurality of child data loggers, and generating a plurality of combined logs via a controller, wherein each combined log is generated by combining the parent log with a respective child log of the plurality of child logs.

In addition to one or more of the features described above, or as an alternative, further embodiments could include releasing at least one child data logger of the plurality of child data loggers from the parent data logger.

In addition to one or more of the features described above, or as an alternative, further embodiments could include initiating at least one respective secondary period of the plurality of secondary periods in response to releasing at least one child data logger of the plurality of child data loggers from the parent data logger.

In addition to one or more of the features described above, or as an alternative, further embodiments could include that the parent data logger and the plurality of child data loggers are electrically coupled.

In addition to one or more of the features described above, or as an alternative, further embodiments could include that the parent data logger and each of the plurality of the child data loggers each has a unique identifier.

In addition to one or more of the features described above, or as an alternative, further embodiments could include that the parameter of interest includes at least one of a temperature value, a humidity value, and a gas level.

Technical function of the embodiments described above includes a parent data logger to log a parameter of interest in a parent log for a primary period, a plurality of child data loggers to log the parameter of interest in a respective plurality of child logs for a respective plurality of secondary periods, a controller to generate a plurality of combined logs.

Other aspects, features, and techniques will become more apparent from the following description taken in conjunction with the drawings.

### BRIEF DESCRIPTION OF THE SEVERAL VIEWS OF THE DRAWINGS

The foregoing and other features, and advantages of embodiments are apparent from the following detailed description taken in conjunction with the accompanying drawings in which like elements are numbered alike in the several FIGURES:

FIG. 1 illustrates a schematic view of an exemplary data logging system;

FIG. 2 is a schematic view of an exemplary child data logger suitable for use with the data logging system of FIG. 1; and

FIG. 3 is a flow diagram of a method of environmental data logging in accordance with an embodiment.

### DETAILED DESCRIPTION

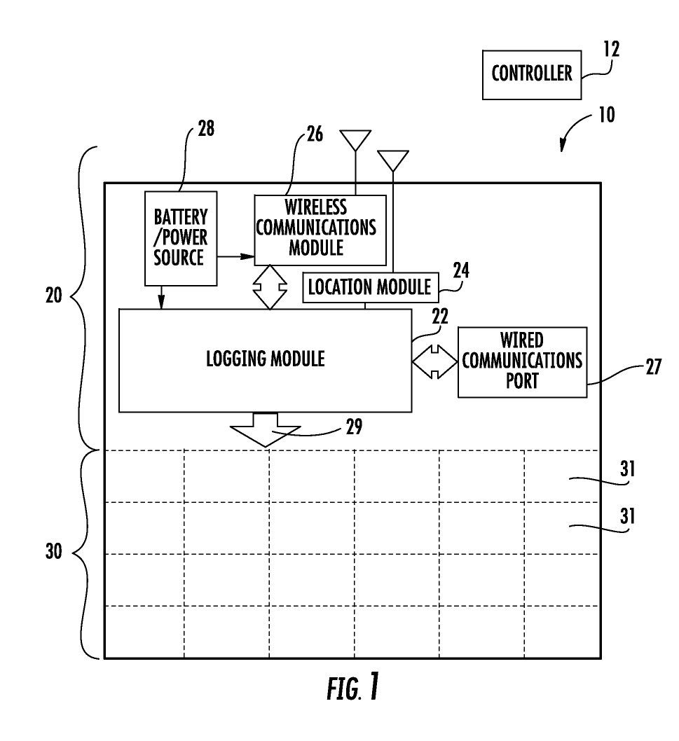

Referring to FIG. 1, an exemplary embodiment of a data logging system 10 is shown. In an exemplary embodiment, data logging system 10 includes controller 12, parent data logger 20, and a plurality of child data loggers 30. Data logging system 10 can facilitate comprehensive data logging of environmental parameters in a cold chain as cargo is divided, reallocated, or otherwise separated during transportation.

Data logging system 10 allows for parent data logger 20 and the plurality of child data loggers 30 to log parameters as a single unit, while allowing separation of the plurality of child data loggers 30 to log parameters of the separated cargo with individual child data loggers 31. In an exemplary embodiment, child data loggers 31 can physically separate from parent data logger 20 to be associated with separated cargo traveling to various destinations to provide discrete logging. Advantageously, comprehensive logs can be created even when cargo is separated or otherwise divided between destinations.

In an exemplary embodiment, parent data logger 20 includes logging module 22, location module 24, wireless communication module 26, wired communication port 27, battery/power source 28, and parent/child interface 29. Parent data logger 20 can log at least one parameter of interest for a primary period of time.

In an exemplary embodiment, logging module 22 can log at least one environmental parameter for a first period of time. In an exemplary embodiment, logging module 22 can utilize at least one sensor to monitor environmental parameters and generate a sensor reading. Environmental parameters may include position data, humidity, time, temperature, shock, vibration, ambient light, and gas emissions (such as carbon dioxide and ethylene). Accordingly, suitable sensors are utilized to monitor the desired parameters. Advantageously, sensors may be selected for certain applications depending on the cargo to be monitored and the corresponding environmental sensitivities. In an exemplary embodiment, temperatures are monitored.

In an exemplary embodiment, readings from sensors are received and logged in memory during a desired monitoring period. In certain embodiments, the readings are further augmented with timestamps, position stamps or other relevant information. In an exemplary embodiment, logs of logging module 22 can include a unique identifier, to identify resultant logs of parent data logger 20 when received by controller 12.

In certain embodiments, logging module 22 can receive and log location data from location module 24. Location module 24 can receive any suitable location data, including but not limited to GPS location data, cellular triangulation data, etc.

In an exemplary embodiment, parent data logger 20 can wirelessly communicate via a wireless communication module 26. Wireless communication module 26 may communicate using any suitable network or method, including, but not limited to infrared, cellular networks, satellite communication networks, private wide area networks, etc. In certain embodiments, wireless communication module 26 communicates with controller 12 or child data loggers 31.

In an exemplary embodiment, parent data logger 20 can transfer data via wired communication port 27 after the cargo has reached a checkpoint or a destination. The wired communication port 27 may transfer data by any suitable local method, including, but not limited to USB, serial transmission, personal area networks, or any other suitable local interface.

In certain embodiments, a battery/power source 28 can provide power to parent data logger 20. In other embodiments, parent data logger 20 can receive power from an external source.

In an exemplary embodiment, parent child interface 29 is a physical and/or electrical interface between parent data logger 20 and the plurality of child data loggers 30. Parent child interface 29 may interface with the entire plurality of child data loggers 30, a subset of the plurality of child data loggers 30, or individual child data loggers 31. In certain embodiments, parent child interface 29 can communicate logging information between parent data logger 20 and the plurality of child data loggers 30. In certain embodiments, parent child interface 29 can trigger the recording of a time stamp within logging module 22 to indicate the beginning or end of a logging period. In an exemplary embodiment, separation of a child data logger 31 from the parent data logger 20 activated the child data logger 31. Advantageously, as an individual child data logger 31 is physically separated from parent child logger 20, the physical and/or electrical separation of the parent child interface 29 can further signal the termination of a primary logging period and/or signal the initiation of a secondary logging period.

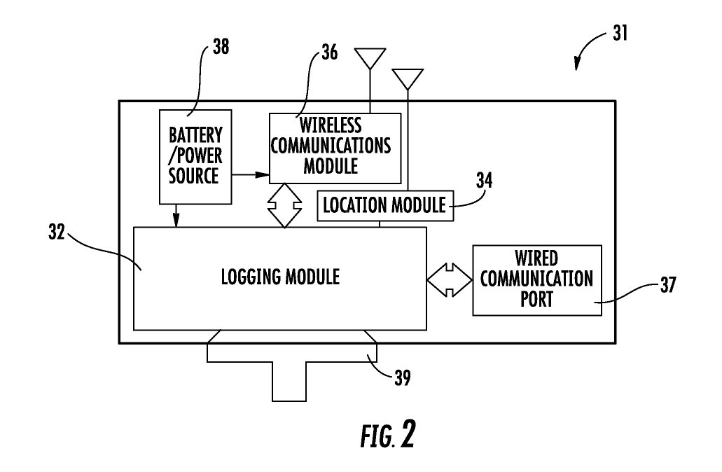

Referring to FIG. 2, a single child data logger 31 of the plurality of child data loggers 30 is shown. Child data loggers 31 can log data for a secondary period of time. In an exemplary embodiment, child data logger 31 can include, but is not limited to logging module 32, location module 34, wireless communication module 36, wired communication port 37, battery/power source 38, and parent child interface 39. In an exemplary embodiment, a plurality of child data loggers 30 can be active at any given time.

In an exemplary embodiment, child data loggers 31 are releasably coupled to parent data logger 20. In certain embodiments, the child data loggers 31 are releasably coupled to each other and parent data logger 20 via perforated printed circuit boards. Perforated printed circuit boards may easily be separated by a user. Child data loggers 31 can be electrically and/or physically separated from parent data logger 20. Advantageously, child data loggers 31 can be associated with various portions of separated cargo, as cargo is separated at distribution centers, or other suitable locations. In certain embodiments, a plurality of child data loggers 30 can be separated from parent data logger 20. In certain embodiments, a subset of child data loggers 31 can be associated with a portion of cargo to be subdivided at a later time. Advantageously, the subset of child data loggers 31 can further be separated to provide data logging for subdivided cargo.

Referring back to FIG. 1, in an exemplary embodiment, controller 12 receives information from parent data logger 20 and the plurality of child data loggers 30 to create a plurality of combined data logs. Controller 12 can be any suitable computing device. Controller 12 may identify the provided logs by utilizing the unique identifiers of logging modules 22 and 32. Controller 12 may further identify and utilize time stamps, location stamps, and other suitable information. In certain embodiments, parent/child relationships can be reflected via the unique identifier, such as a serial numbering schema of parent data logger 20 and child data loggers 31.

After the data logs are identified and the parent/child relationship of the logs are identified, a combined data log for each separate child data logger 31 can be created. Advantageously, the combined data log provides comprehensive information of the cargo from the source to the destination, simulating the use of a dedicated data logger associated with the cargo. By utilizing data logging system 10, fewer hardware components are required and costs are reduced. Individual data logs may still be reviewed and analyzed via controller 12.

In certain embodiments, data logging system 10 can include multiple levels of parent/child relationships. For example, a plurality of child data loggers 30 may be divided and subdivided before a final destination. Controller 12 may similarly identify the resulting data logs and create a combined data log for each separate child data logger 31 by identifying and combining the data logs of parent data logger 20, and any child data loggers 31 that have served in a “parent” relationship.

Controller 12 may be integrated with parent data logger 20 or controller 12 may be a separate component. In certain embodiments, controller 12 includes data analytics software. In certain embodiments, controller 12 can utilize wireless communication with parent data logger 20 and/or child data loggers 31 to perform real time analysis. Controller 12 may further allow for proper routing and dispatch information, while allowing greater visibility and traceability.

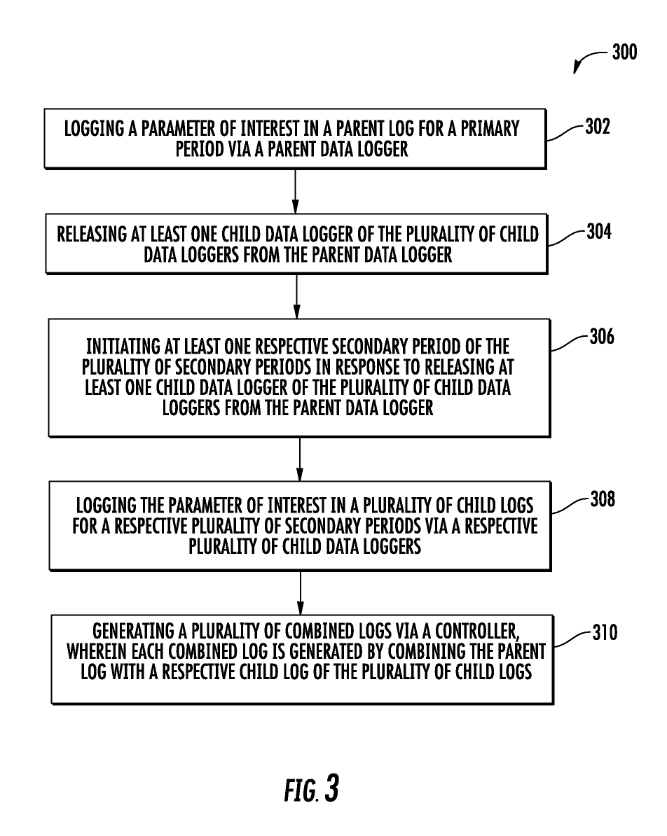

Referring to FIG. 3, method 300 for logging data is shown. In operation 302 a parent data logger logs a parameter of interest in a parent log for a primary period. A parent log may be representative of an undivided cargo.

In operation 304, at least one child data logger of the plurality of child data loggers is released from the parent data logger. Child data loggers may be associated with separated or divided portions of the undivided cargo. Advantageously, subsets or groups of child data loggers can be associated with the divided portions to allow further divisions of the cargo.

In operation 306, in response to the release of the child data loggers from the parent data loggers, the respective secondary logging period of the released child data loggers is initiated. In operation 308, the parameter of interest is logged in each of the plurality of child data loggers on a respective child data log. Child data loggers can perform secondary logging of the divided cargo, which may be subject to different environmental parameters from the previous, undivided cargo, as well as other parallel divided cargo.

In operation 310 the plurality of combined logs are generated via a controller by combining the parent log with a respective child log of the plurality of child logs. The logs from the parent data logging device is combined with each of the child logs from the child logging devices to provide a complete log for each divided and monitored portion of cargo. Advantageously, the combined logs provide cargo parameter information from a source to a destination.

The terminology used herein is for the purpose of describing particular embodiments only and is not intended to be limiting of embodiments. While the description has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the present disclosure. Additionally, while the various embodiments have been described, it is to be understood that aspects may include only some of the described embodiments. Accordingly, the present disclosure is not to be seen as limited by the foregoing description, but is only limited by the scope of the appended claims.

What is claimed is:

1. A data logging system comprising:
a parent data logger to log a parameter of interest in a parent log for a primary period;
a plurality of child data loggers to log the parameter of interest in a respective plurality of child logs for a respective plurality of secondary periods;
a controller to generate a plurality of combined logs, wherein each combined log is generated by combining the parent log with a respective child log of the plurality of child logs.

2. The data logging system of claim 1, wherein the parent data logger and each of the plurality of child data loggers are releasably coupled.

3. The data logging system of claim 2, wherein at least one respective secondary period of the plurality of secondary periods is initiated in response to releasing at least one child data logger of the plurality of child data loggers from the parent data logger.

4. The data logging system of claim 2, wherein the parent data logger and the plurality of child data loggers are electrically coupled.

5. The data logging system of claim 1, wherein the parent data logger and each of the plurality of the child data loggers each has a unique identifier.

6. The data logging system of claim 1, wherein the parameter of interest includes at least one of a temperature value, a humidity value, and a gas level.

7. The data logging system of claim 1, wherein the parent data logger and the plurality of child data loggers log at least one time stamp.

8. The data logging system of claim 1, wherein the parent data logger and the plurality of child data loggers log at least one location value.

9. The data logging system of claim 1, wherein the parent data logger and the plurality of child data loggers each include at least one of a wireless data interface and a wired data interface.

10. A method to log data, comprising:
logging a parameter of interest in a parent log for a primary period via a parent data logger;
logging the parameter of interest in a plurality of child logs for a respective plurality of secondary periods via a respective plurality of child data loggers; and
generating a plurality of combined logs via a controller, wherein each combined log is generated by combining the parent log with a respective child log of the plurality of child logs.

11. The method of claim 10, further comprising releasing at least one child data logger of the plurality of child data loggers from the parent data logger.

12. The method of claim 11, further comprising initiating at least one respective secondary period of the plurality of secondary periods in response to releasing at least one child data logger of the plurality of child data loggers from the parent data logger.

13. The method of claim 11, wherein the parent data logger and the plurality of child data loggers are electrically coupled.

14. The method of claim 10, wherein the parent data logger and each of the plurality of the child data loggers each has a unique identifier.

15. The method of claim 10, wherein the parameter of interest includes at least one of a temperature value, a humidity value, and a gas level.
